(19) United States
(12) Patent Application Publication
(10) Pub. No.: US 2024/0359980 A1
(43) Pub. Date: Oct. 31, 2024

(54) HYDROGEN PRODUCTION SYSTEM

(71) Applicant: ZEG Power AS, Fornebu (NO)

(72) Inventors: Arnstein NORHEIM, Kongsberg (NO); Margrethe STENRØD WEST, Stabekk (NO); Vidar GRAFF, Fornebu (NO)

(21) Appl. No.: 18/291,800

(22) PCT Filed: Aug. 2, 2022
(86) PCT No.: PCT/EP2022/071679

§ 371 Date: Jan. 24, 2024

(30) Foreign Application Priority Data
Aug. 9, 2021 (EP) 21190415.6

(51) Int. Cl. C01B 3/56; B01D 53/34; B01D 53/62; B01D 53/83; B01D 53/96; C01B 3/40; C01B 3/44

(52) U.S. Cl. CPC C01B 3/56; B01D 53/346; B01D 53/62; B01D 53/83; B01D 53/96; C01B 3/40; C01B 3/44; B01D 2251/404; B01D 2251/602; B01D 2256/16; B01D 2257/504; B01D 2258/02; C01B 2203/0233; C01B 2203/0425; C01B 2203/0475; C01B 2203/1058; C01B 2203/1241; C01B 2203/148; C01B 2203/1685

(57) ABSTRACT

A system and method for producing hydrogen gas. The system comprises at least one reformer reactor, at least one separator, at least one separator transport line, at least one regenerator reactor, at least one regenerator transport line and at least one recycling line. The reformer reactor is for containing a CO₂ capturing sorbent A forming a used sorbent A*, wherein the reformer reactor is configured to allow reform of a feed material B and a steam C to produce a reformate gas mixture comprising H₂ and CO₂. The reformer reactor comprising a reformer inlet for feeding at least one of B and C into the reformer reactor and a reformer outlet for ejecting A* and H₂. A separator configured to separate A* from H₂. The separator comprising a separator inlet for feeding H₂ and A* into the separator and a separator outlet for ejecting the separated A *. A separator transport line for transporting A* and H₂ from the reformer outlet to the separator inlet. The regenerator reactor comprising a regenerator inlet for receiving at least a portion of A* separated in the separator. A regenerator power source configured to provide sufficient energy to the received A* for allowing release of CO₂, thereby regenerating the sorbent. A regenerator outlet for ejecting the regenerated sorbent. A regenerator transport line for transporting the flow of A* from the separator outlet to the regenerator inlet. A recycling line arranged to transport at least a portion of the regenerated sorbent from the regenerator outlet into the reformer reactor. The regenerator transport line comprises a flow regulating device arranged to adjust the flow rate of A* being transported into the regenerator inlet.

### FIELD OF THE INVENTION

The present invention relates to hydrogen production and a method thereof. More particularly, the invention relates to a system and a method for producing hydrogen gas using a sorbent material to capture carbon dioxide produced during a reforming reaction in a reformer reactor and where used sorbent is separated and controllably fed into a regenerator reactor.

### BACKGROUND AND PRIOR ART

Due to a rapid increasing in use of hydrogen fuel as energy carrier, supply of hydrogen to industrial users has become a major business around the world.

Hydrogen can be extracted from fossil fuels and biomass, from water, or from a mix of both. Natural gas is currently the primary source of hydrogen production.

Today, hydrogen fuel is produced through a variety of methods. The most common methods are natural gas/methane reforming, coal gasification and electrolysis. Other methods include solar-driven and biological processes.

See e.g. https://www.energy.gov/eere/fuelcells/hydrogen-fuel-basics

### Conventional SMR

In conventional steam methane reforming (SMR), a gas mixture consisting of hydrogen (H₂) and carbon monoxide (CO) is created when steam reacts with methane in the presence of a catalyst at high temperatures (800-1000° C.) and high pressure (15-20 bar), see reaction (2.1). Subsequently, carbon dioxide (CO₂) and additional hydrogen are produced in a lower temperature (300-400° C.) environment by a water-gas shift reaction (2.2) which involves reacting the carbon monoxide with steam using a catalyst. The hydrogen gas is then separated from CO₂ by for example pressure-swing adsorption in several steps until the desired hydrogen purity is achieved.

The main reactions in conventional SMR are as follows:

Reforming: CH₄(g)+H₂O(g)↔CO(g)+3H₂(g) (2.1)

Shift: CO(g)+H₂O(g)↔CO₂(g)+H₂(g) (2.2)

Overall: CH₄(g)+2H₂O(g)↔CO₂(g)+4H₂(g) (2.3)

Conventional SMR suffers from several disadvantages such as need of large fixed beds to minimize pressure drops, deactivation of catalysts due to carbon formation and need of maintaining high reactor temperatures since only a part of the combustion heat is used directly into the process.

### Sorption-Enhanced SMR (SE-SMR)

The SE-SMR process reduces processing steps by adding a CO₂-sorbent such as calcium oxide (CaO) or dolomite to the reformer reactor together with a catalyst. When the sorbent is added to the reactor, the CO₂ is converted to solid carbonate (CaCO₃) in an exothermic calcination reaction (2.4), resulting in a product gas from the reformer consisting mainly of H₂ and H₂O, with minor amounts of CO, CO₂ and unconverted CH₄ (fuel gas). Adding the sorbent thus results in a forward shift of reactions (2.1)-(2.3) and thus improves methane conversion and hydrogen yield. The exothermic reaction leads to a near autothermal process operating in temperatures ranging from 550 to 650° C.

The main reactions in SE-SMR are, in addition to reactions (2.1)-(2.2), as follows:

Carbonation: CaO(s)+CO₂(g)↔CaCO₃(s) (2.4)

Overall: CH₄(g)+2H₂O(g)+CaO(s)↔CaCO₃(s)+4H₂(g) (2.5)

In continuous production, the carbonated sorbent, saturated by CO₂, is subsequently transported to a regenerator reactor where it is exposed to high temperature for ensuring that an endothermic calcination reaction (2.6) to take place.

Calcination/Regeneration: CaCO₃(s)↔CaO(s)+CO₂(g) (2.6)

Depending on the configuration of the reactor, the saturated sorbent is heated to around 900° C. for the endothermic reaction of releasing the CO₂ from the carbonated limestone, CaCO₃.

The resulting regenerated sorbent (CaO) is subsequently transported back to the reformer reactor and the CO₂ released from the used sorbent is transported to an external location, typically a CO₂ handling or storage facility.

Heat delivered to the regenerator reactor must both raise the temperature of the saturated sorbent entering the bed and provide excess heat sufficient for the calcination reaction to be carried out. The heat source may for example be waste heat from a solid oxide fuel cell (SOFC). Sorbent saturated by CO₂ is typically called ‘used sorbent’.

The above SE-SMR may be carried out in both fixed and fluidized bed reactors. However, the use of fluidized bed reactors is considered advantageous due to their high acceptance of continuous feeding and withdrawal of fluids/particulates (thus allowing higher degree of continuous operation), efficient and near isothermal heat distribution, efficient mixing of chemical reactants, higher suitability for large scale operation, lower pressure drops and higher heat transfer between the bed and immersed bodies.

The fluidizing medium for SE-SMR regenerator may in principle be any gas that can be easily separated from CO₂. Steam is considered ideal in this respect since steam condenses at a significantly higher temperature than CO₂. The fluidizing medium for SE-SMR reformer is typically a mixture of steam and hydrocarbon gas, with a steam-to-carbon ratio S/C of 2.5/1 to 4/1.

SE-SMR is known in the field. See for example international patent publication WO 2016/191678 A1 disclosing a system for hydrogen production via sorption enhanced reforming. In this prior art system, the sorbent material CaO within the reformer reactor acts to adsorb CO₂ to form a used sorbent in form of CaCO₃. The used sorbent is further guided into an atmospheric regenerator reactor to heat the used sorbent to desorb CO₂ from the used sorbent, thereby producing regenerated sorbent that is recycled to the reformer reactor. Patent publications U.S. Pat. No. 8,241,374 B2, WO 2018/162675 A3, WO 2018/148514 A1 and US 2019/0112188 A1 describes other examples of sorption enhanced SMR.

None of the systems described in the above-mentioned patent publications provide information concerning control of the flow rates of used sorbent between the reformer reactor and the regenerator reactor.

An objective of the present invention is therefore to allow control of the flow rates of used sorbent within the system.

### SUMMARY OF THE INVENTION

The present invention is set forth and characterized in the independent claims, while the dependent claims describe other characteristics of the invention.

In a first aspect, the invention concerns system for producing hydrogen gas H₂.

The system comprises at least one reformer reactor, at least one separator, at least one separator transport line, at least one regenerator reactor, at least one regenerator transport line and at least one recycling line.

The reformer reactor(s) has/have an enclosed volume for containing a carbon dioxide capturing sorbent A forming a used sorbent A* when conditions for capturing carbon dioxide such as minimum pressure and/or minimum temperature and/or minimum amount per volume unit are present. The reformer reactor is configured to allow reforming of a feed material B (such as a hydrocarbon fuel) and a steam C (i.e. water predominantly in gas phase) to produce a reformate gas mixture comprising hydrogen gas H₂ and carbon dioxide CO₂. The reformer reactor comprises at least one reformer inlet for feeding at least one of the feed material B and the steam C into the reformer reactor and at least one reformer outlet for ejecting the used sorbent A* and the hydrogen gas H₂. More preferably the reformer reactor comprises at least two reformer inlets including a feed material inlet and a steam inlet. The reformer reactor(s) may comprise an additional inlet for feeding the carbon dioxide capturing sorbent into the reformer reactor.

The separator(s), for example a cyclone, is/are configured to separate the used sorbent A* from the hydrogen gas H₂. The separator(s) comprise(s) at least one separator inlet for feeding the hydrogen gas H₂ and the used sorbent A* into the separator(s) and at least one separator outlet for ejecting the separated used sorbent A*.

The separator transport line(s) is/are suitable for transporting the used sorbent A* and the hydrogen gas H₂ from the reformer outlet to the separator inlet.

In a preferred configuration, the reformer reactor may comprise two reformer outlets, one reformer outlet arranged in an upper part of the reformer reactor for discharging gas, mainly hydrogen gas H₂, and one reformer outlet arranged in a lower part of the reformer reactor for discharging mainly used sorbent A*. In this configuration, the hydrogen gas H₂ and used sorbent A* exiting the reformer reactor can be mixed in the separator transport line(s) and enter the separator(s). In case vertical transport of the hydrogen gas H₂ flow and used sorbent A* between the reformer reactor and the separator is required, it may be advisable to install a dedicated vertical transport device, such as a transport riser. An example of such a transport riser may be a pipe section with a diameter that ensures particle entrainment by the transport gas, i.e. the gas velocity is sufficiently high, and with a bottom part that prevents or limits accumulation of particles.

Furthermore, the regenerator reactor(s) comprise(s) at least one regenerator inlet for receiving at least a portion of the used sorbent A* separated in the separator(s), at least one regenerator power source configured to provide energy to the received used sorbent A* for allowing release of carbon dioxide CO₂, thereby regenerating the sorbent A, and at least one regenerator outlet for ejecting the regenerated sorbent A, at least one regenerator transport line for transporting the flow of the used sorbent A* from the separator outlet(s) to the regenerator inlet(s) and at least one recycling line arranged to transport at least a portion of the regenerated sorbent A from the regenerator outlet(s) into the reformer reactor(s), for example via the one or more reformer inlets or via one or more dedicated recycling inlets.

The regenerator transport line, or each of the regenerator transport lines, may advantageously comprise at least one flow regulating device arranged to adjust the flow rate R_{A*} [m³/s or kg/s] of the used sorbent A* being transported into the regenerator inlet.

In one exemplary configuration of the invention, the regenerator transport line further comprises at least one tank for containing the separated used sorbent A*, at least one first regenerator transport line coupled at one end to the separator outlet(s) and the other end to at least one tank inlet of the tank and at least one second regenerator transport line coupled at one end to at least one tank outlet of the tank, and the other end to the regenerator inlet. One or more measuring device(s) may be connected to the tank(s) for measuring the amount of used sorbent A* stored there within.

In another exemplary configuration of the invention, the regenerator transport line(s) further comprise(s) at least one valve arranged to open or stop the flow of the separated used sorbent A* transported through the regenerator transport line(s). The valve(s) may for example be arranged in the first regenerator transport line(s) to stop or start the flow into the tank(s).

In yet another exemplary configuration of the invention, the flow regulating device(s) comprise(s) at least one screw conveyor arranged to rotate at an adjustable rotation speed v, to regulate the flow rate R_{A*} of the used sorbent A* into the regenerator reactor(s). A screw conveyor is typically a mechanism that uses a rotating helical screw blade allowing movement of liquids and/or solids such granular materials.

Said screw conveyor is preferably configured such that the used sorbent A* is transported into the regenerator reactor at a higher flow rate R_{A*,H} and a lower flow rate R_{A*,L} when the screw conveyor is rotating at a higher rotation speed v_{r;H} and at a lower rotation speed v_{r,L}, respectively.

Furthermore, the flow regulating device is preferably further comprising a motor, for example an electrical motor, rotationally connected to the screw conveyor, thereby enabling said adjustable rotation speed vᵣ and a variable speed drive/a frequency changer connected to the motor to enable control of the rotation speed of the motor and thereby the rotation speed of the screw conveyor.

In yet another exemplary configuration of the invention, the system further comprises an automatic controller in signal communication with the flow regulating device, for example the variable speed drive and/or directly with the motor. The controller may in this exemplary configuration be designed and programmed to automatically control operation of the flow regulating device, and thereby the flow rate R_{A*}, based on at least one of
a flow rate of feed material B flowing into the reformer reactor,
a flow rate of steam C flowing into the reformer reactor and
a flow rate of a mixture of feed material B and steam C flowing into the reformer reactor,
a flow rate of the used sorbent A* flowing between the reformer outlet and the regenerator inlet,
a flow rate of at least carbon dioxide CO₂ flowing between the reformer and the regenerator inlet, and preferably also a flow rate of carbon monoxide CO, and
a flow rate of gas, mainly hydrogen gas, flowing out of the separator.

In yet another exemplary configuration of the invention, the system further comprises an automatic controller in signal communication with the flow regulating device, the controller being configured to automatically control operation of the flow regulating device, and thereby the flow rate R_{A*}, based on at least one of
composition ratios of feed material B relative to the total flow of steam C and feed material B flowing into the reformer reactor,
composition ratios of the chemical compounds (typically H₂, CO, CO₂ and CH₄) of the fluid flowing between the reformer outlet and the regenerator inlet,
gas composition ratio between carbon monoxide CO and unconverted fuel gas (typically CH₄) flowing between the reformer outlet and the regenerator inlet,
gas composition ratio between carbon dioxide CO₂ and unconverted fuel gas (typically CH₄) flowing between the reformer outlet and the regenerator inlet,
general gas composition measurements in the hydrogen line to detect for example any decline of CO₂ capturing within the reformer reactor (200).

Gas composition measurements may be achieved by several known measurement techniques, such as gas chromatography.

In yet another exemplary configuration of the invention, the regenerator reactor further comprises a regenerator vessel enclosing the inner volume and into which the used sorbent A* may flow. In this configuration the regenerator power source may be arranged outside the regenerator vessel, supplying power into the inner volume.

The regenerator power source arranged outside the vessel may be a heat source such as a burner, or waste heat from for example a high temperature solid oxide fuel cell (SOFC), thereby ensuring release of the carbon dioxide from the used sorbent by supplying heat indirectly through the vessel walls. The burner may be a gas burner, coal burner, oxy-fuel burner and/or oil burner. Indirect heat exchange between the power source to the regenerator may require the integration of a high temperature heat exchanger in the regenerator bed section for transferring heat from the power source to the regenerator bed material.

Alternatively, or in addition, at least a part of said power source, or an additional power source, may be arranged inside the regenerator vessel, typically at the bottom of the vessel, thereby enabling supply of energy such as hot gas directly to the used sorbent A*. Any combustion products resulting from the internal power source (for example from an oxy-fuel burner) may be used for other applications, such as fluidization of a regenerator bed. Direct heat transfer between the power source and the regenerator, when the power source is an oxy-fuel burner, may require the use of an air separation unit to provide oxygen feed to the oxy-fuel burner.

In yet another exemplary configuration of the invention, the system further comprises at least one hydrogen transport line for transporting flow of hydrogen gas H₂ having been separated from the used sorbent A* within the separator via at least one second separator outlet to one or more external locations. At least one external location may be a location which includes an arrangement for purifying at least a portion of the flow of hydrogen gas H₂.

In yet another exemplary configuration of the invention, the system further comprises at least one CO₂ transport line for transporting flow of carbon dioxide CO₂ having been released from the used sorbent A* within the regenerator via at least one second regenerator outlet to one or more external locations. At least one external location may be a location which includes an arrangement for storing at least a portion of the flow of carbon dioxide CO₂.

In a second aspect, the invention concerns system as described above, wherein the reformer reactor includes an amount of the feed material B and an amount of steam C. The feed material B may comprise one or more types of hydrocarbon containing fuel such as natural gas, methane rich gases, syngas, mixture methane rich gas and syngas, gases from the gasification of organic matter such as biomass or carbons/hydrocarbons, and gas-hydrates.

In an exemplary configuration of the second aspect of the invention, the reformer reactor includes an amount of the sorbent A. The sorbent A may be a metal oxide such as calcium oxide, and the used sorbent A* may be a metal carbonate such as calcium carbonate. In another exemplary configuration of the second aspect of the invention, the reformer reactor(s) and/or the regenerator reactor(s) include(s) a fluidized bed, thereby achieving several benefits, for example a high surface area contact between the sorbent A and the reformate gas mixture B, C, an increased or improved temperature homogeneity and/or an increased heat transfer.

In another exemplary configuration of the second aspect of the invention, the reformer reactor is selected from the group consisting of
i) a reformer reactor configured to support sorption enhanced steam methane reforming,
ii) a reformer reactor configured to support sorption enhanced water gas shift, or
iii) a combination of i) and ii).

In a third aspect, the invention concerns a method for producing hydrogen gas H₂ using the above described system.

The method comprising the steps of:
A. introducing the feed material B (such as hydrocarbon fuel) and the steam C into the reformer reactor(s) via the one or more reformer inlets, the reformer reactor(s) containing the sorbent A for capturing carbon dioxide CO₂,
B. reforming the feed material B and the steam C within the reformer reactor(s) for producing the reformate gas mixture comprising the hydrogen gas H₂ and the carbon dioxide CO₂, wherein the sorbent A is capturing the carbon dioxide CO₂ to form the used sorbent A*,
C. transporting at least a portion of the used sorbent A* and at least the portion of the hydrogen gas H₂ from the reformer reactor(s) to the separator(s) through the separator transport line(s),
D. separating the used sorbent A* from the hydrogen gas H₂ by operating the separator(s),
E. transporting at least a portion of the used sorbent A* from the separator(s) to the regenerator reactor(s) through the regenerator transport line(s) while adjusting the flow rate R_{A*} of the used sorbent A* by operating the regulating device(s),
F. providing energy such as heat to the used sorbent A* within the regenerator reactor(s) to release at least a portion of the carbon dioxide CO₂ captured by the used sorbent A*, thereby at least partly regenerating the sorbent A of step A, and
G. recycling at least a portion of the regenerated sorbent A of step F by transporting the regenerated sorbent A from the regenerator reactor(s) to the reformer reactor(s) through the recycling line(s).

The sorbent A may be a metal oxide such as calcium oxide, and the used sorbent A* may be a metal carbonate such as calcium carbonate.

The heat provided by the recycled regenerated sorbent A through the recycling line(s) may be sufficient to ensure the desired processes within the reformer reactor(s) to produce the reformate gas and to capture the carbon dioxide CO₂ into the sorbent A. However, the reformer reactor may be provided with a separate power source such as an external heat source.

In an exemplary process of the third aspect of the invention, the flow regulating device(s) comprise(s) at least one screw conveyor and wherein the adjustment of the flow rate R_{A*} in step E is achieved by adjusting the rotation speed(s) vᵣ of the screw conveyor(s).

In another exemplary process of the third aspect of the invention, adjusting the rotation speed(s) vᵣ of the screw conveyor(s) in step E further comprises adjusting the screw conveyor(s) to a higher rotation speed v_{r,H} or higher rotation speeds v_{r,H} for transporting the used sorbent A* to the regenerator reactor(s) at a higher flow rate R_{A*,H} or higher flow rates R_{A*,H}, and adjusting the screw conveyor(s) to a lower rotation speed v_{r,L} or lower rotation speeds v_{r,L} for transporting the used sorbent A* to the regenerator reactor(s) at a lower flow rate R_{A*,L} or lower flow rates R_{A*,L}.

In yet another exemplary process of the third aspect of the invention, the flow regulating device(s) further comprise(s) at least one motor rotationally connected to the screw conveyor(s), and at least one variable speed drive connected to the motor(s).

In this exemplary process, the step of adjusting the rotation speed(s) vᵣ of the screw conveyor(s) in step E may further comprise operating the variable speed drive(s) for changing the rotation speed(s) of the motor(s), thereby adjusting the rotation speed vᵣ of the screw conveyor(s) connected to the motor(s).

In yet another exemplary process of the third aspect of the invention, the regenerator transport line(s) further comprises at least one valve, and wherein step E further includes operating the valve(s) to open or stop the flow(s) of the separated used sorbent A* transported through the regenerator transport line(s).

In yet another exemplary process of the third aspect of the invention, the regenerator transport line(s) further comprises at least one tank for containing the separated used sorbent A*, at least one first regenerator transport line coupled at one end to the separator outlet(s) and the other end to tank inlet(s) of the tank(s) and at least one second regenerator transport line coupled at one end to tank outlet(s) of the tank(s) and the other end to the regenerator inlet(s), and wherein step E further includes filling the tank(s) to predetermined minimum amount(s) of the separated used sorbent A*. The system may further comprise at least one measuring device for measuring the amount(s) of the used sorbent A* stored within the tank(s).

The above described valve(s) may for example be arranged in the first regenerator transport line(s) to stop or start the flow(s) into tank(s) described below.

In yet another exemplary process of the third aspect of the invention, the regenerator reactor(s) further comprises a regenerator vessel having an enclosed inner volume into which the used sorbent A* may flow. In this exemplary process the regenerator power source(s) may be arranged outside the regenerator vessel to provide indirect heating to the regenerator vessel, and step F of providing energy to the used sorbent

A* within the regenerator reactor may comprise transporting energy such as heat from the regenerator power source(s) into the regenerator vessel.

In yet another exemplary process of the third aspect of the invention, the step of reforming the feed material (B) and steam (C) comprises reforming by use of a reformer reactor (100) selected from the group consisting of i) a reformer reactor configured to support sorption enhanced steam methane reforming, ii) a reformer reactor configured to support sorption enhanced water gas shift, or iii) a combination of i) and ii).

In yet another exemplary process of the third aspect of the invention, the reformer reactor(s) is operating at a pressure of at least 1.1 bara, more preferably at least 1.3 bara.

In yet another exemplary process of the third aspect of the invention, the regenerator reactor(s) is operating at a pressure of at least 1.1 bara, more preferably at least 1.3 bara.

In yet another exemplary process of the third aspect of the invention, the method further comprises the step of transporting flow of hydrogen gas H₂ separated from the used sorbent A* within the separator(s) during step D from the separator(s) via second separator outlet(s) to external location(s).

In yet another exemplary process of the third aspect of the invention, the external location(s) may be location(s) including arrangement for purifying at least a portion of the flow(s) of hydrogen gas H₂. The purification step may comprise a pressure swing adsorption.

In yet another exemplary process of the third aspect of the invention, the method further comprises the step of transporting a flow of carbon dioxide CO₂ released from the used sorbent A* within the regenerator vessel during step F from the regenerator reactor via a dedicated CO₂ outlet to an external location.

In yet another exemplary process of the third aspect of the invention, the external location may be a location including an arrangement for handling and/or storing at least a portion of the flow of carbon dioxide CO₂. The ability to control the flow rate RA* of the used sorbent A* in a hydrogen production system using an SE-SMR technology as described above, several advantages are achieved.

Controlling the flow rate R_{A*} of the used sorbent A* transported through the regenerator transport lines by adjusting a flow regulating device (such as the rotation velocity of a screw conveyor), results in a control of the amount of solids/used sorbents going into the regenerator reactor. And since any regenerated sorbent A in the regenerator reactor is fed back into the reformer reactor, adjustments of the flow regulating device achieve high degree of control of the entire circulation flow rate of particulates involved in the sorbent looping process, and thereby high degree of control of the amount of CO₂ captured and released in the sorbent looping process. Adjustments of the flow regulating device further enables the system and method to switch between feed material with little or no carbon dioxide (CO₂) and feed material (B) with considerable amount of initial carbon dioxide (CO₂), and thereby to supply a variable amount of sorbent to the reformer reactor according to variable content of CO₂ in the feed material (B).

Furthermore, both the reformer reactor and the regenerator reactor can only hold a certain amount of solids. Assuming that beds in the reactors are fluidized and levelized, if the maximum amount of solids in one of the reactors are exceeded the surplus solids continue to flow within the system loop to the other reactor due to their mutual direct couplings.

If the circulation rate is too low, the reformer reactor does not receive sufficient regenerated sorbent such as CaO compared to the amount of available CO₂ in gas formed in the reforming process (see reaction 2.2-water gas shift). Continued cycling would therefore eventually result in used sorbent (saturated solids) A* only within the reformer reactor, which again would result in no or insignificant capturing/absorption of CO₂.

Since CO₂ capturing in the reformer reactor comes to a halt due to the lack of (non-used) sorbent A, more and more CO₂ will leave the reformer reactor in gas phase. Such increase in CO₂ discharge may be monitored by measuring the reformate composition as described above, for example using gas chromatography. Furthermore, due to the looped coupling between the reactors, monitoring reduction of CO₂ discharge from the regenerator reaction in gas form also provides a measure of decrease in CO₂ capturing in the reformer reactor since no additional CO₂ is added into the system loop.

It is therefore considered highly advantageous that there is sufficient sorbent (e.g. CaO) going into the reformer reactor from the regenerator reactor at any given time to ensure optimal operation of the system.

Too high circulation rate caused by too large amount of sorbent (CaO) in the reformer reactor is considered less problematic compared to too low circulation rate. However, a circulation rate above a certain threshold is considered undesirable since this would reduce the residence time of CO₂ in the regenerator reactor, thereby risking a reduced discharge of CO₂ therefrom. In order to ensure sufficient regeneration, the amount of power supplied to the used sorbent may have to be increased.

### BRIEF DESCRIPTION OF THE DRAWINGS

Following drawings are appended to facilitate the understanding of the invention. The drawings show embodiments of the invention, which will now be described by way of example only, where:

FIG. 1 shows a system for producing hydrogen gas using sorbent in accordance with a first embodiment of the invention,

FIG. 2 shows the system of FIG. 1 where typical compositions, flows and temperatures are indicated,

FIG. 3 shows further details of a dosing system with a flow regulating device and a control system and

FIG. 4 shows a system for producing hydrogen gas using sorbent in accordance with a second embodiment of the invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

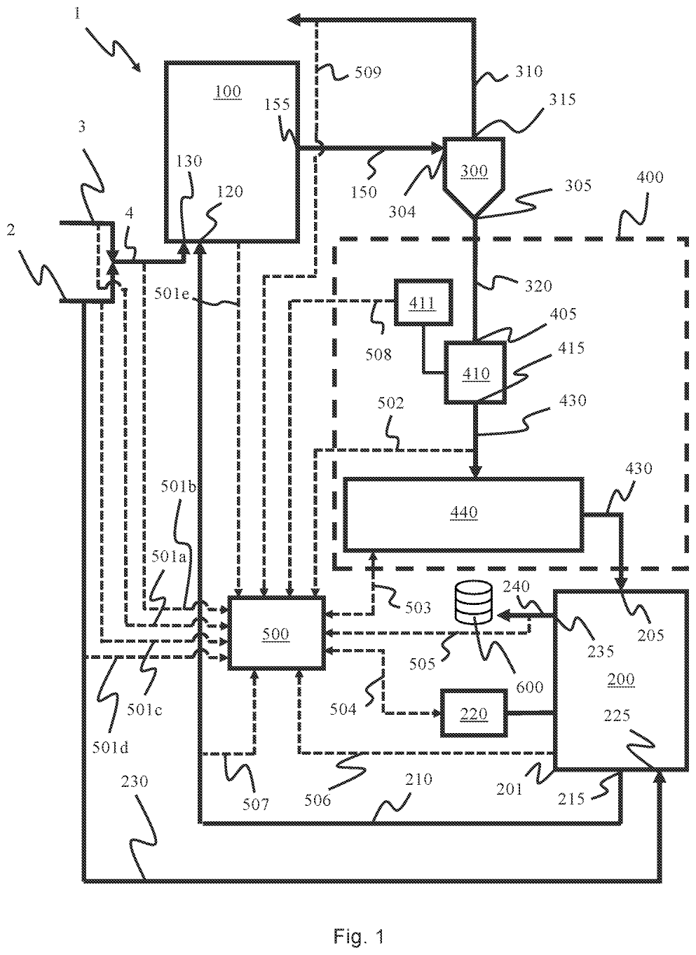

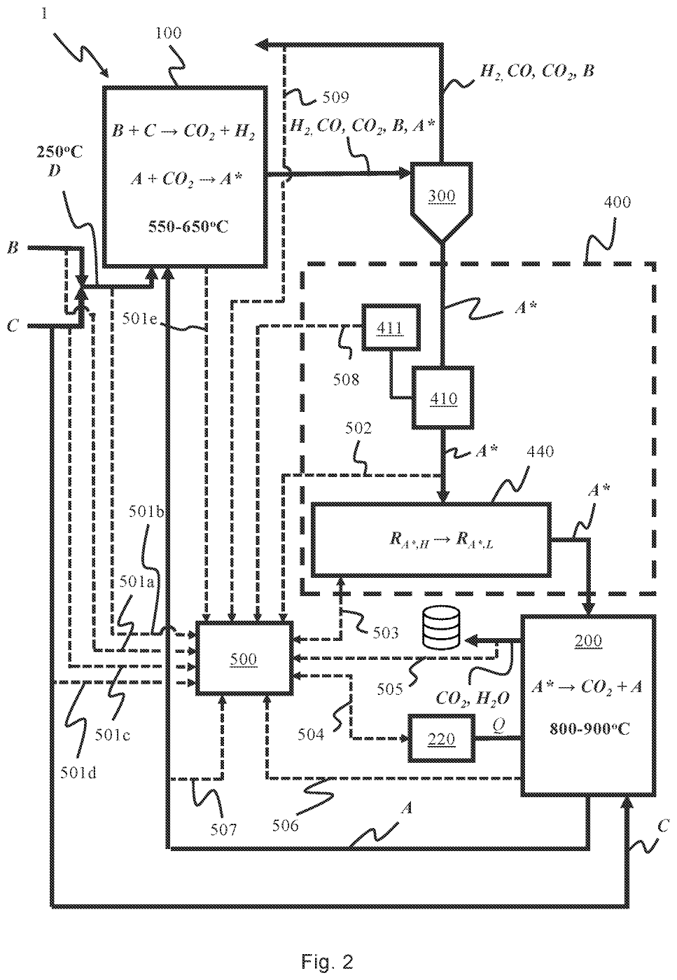

With particular reference to FIGS. 1 and 2, the inventive system 1 for production of hydrogen gas includes at least two reactors; a reformer reactor 100 and a regenerator reactor 200.

Firstly, a fluidized bed such as a bubbling fluidized bed (BFB), a catalyst such as a nickel catalyst and a sorbent A such as calcium oxide (CaO) are installed within the reformer reactor 100.

In order to control the temperature of the fluidized bed, a heat exchanger may be inserted into the reactor carrying cooling or heating fluids into the bed. However, as will be further explained below, such a heat exchanger may be omitted in this particular system since the required reformer reactor temperature to ensure the desired reactions there within may be achieved by feedback of heated regenerated sorbent A.

Fuel/feed material B such as natural gas/methane (CH₄) flowing in a fuel material line 3 and a gas separable from CO₂ such as steam C flowing in steam line 2 is guided into a common feed line 4 as a mixture D. The mixture D then enters the reformer reactor 100 via a reformer inlet 130. The temperature of the mixture D is typically between 200° C. and 300° C., for example 250° C. The pressure and flow rate of the mixture D may be between 1.0 bar absolute (bara) and 1.4 bara (typically 1.2 bara) and between 375 kg/h and 425 kg/h (typically 392 kg/h), respectively.

Moreover, typical values of temperature, pressure and flow rate within the fuel material line 3 and the steam line 2 are 120° C. (±20° C.)/1.4 bara (±0.4 bara)/73 kg/h (±15 kg/h) and 120° C. (±20° C.)/1.4 bara (±0.4 bara)/318 kg/h (±50 kg/h), respectively.

Alternatively, the fuel material B and the gas C may enter the reformer reactor 100 through separate inlets.

When the exemplary fluids and particulates are used, the following reactions take place in the reformer reactor 100:

Reforming: CH₄(g)+H₂O(g)↔CO(g)+3H₂(g) (2.1)

Shift: CO(g)+H₂O(g)↔CO₂(g)+H₂(g) (2.2)

Carbonation: CaO(s)+CO₂(g)↔CaCO₃(s) (2.4)

The reforming and shift reactions are endo-and exothermal, respectively, and the carbonation reaction is exothermal.

Overall: CH₄(g)+2H₂O(g)+CaO(s)↔CaCO₃(s)+4H₂(g) (2.5)

The CO₂-gas is thus captured by sorbent A (here in the form of CaO particulates) within the fluidized bed to form used sorbent A* (here in form of CaCO₃ particulates).

The produced H₂-gas and the used sorbent A* is further guided through a separator transport line/tube 150 and into one or more separators 300 via reformer outlet(s) 155 and separator inlet(s) 304.

The separator 300 is configured to separate at least H₂-gas from the used sorbent A* and is preferably of type inertial separator in which the used sorbent A* is removed from the gas using centrifugation as the driving separating force. Other separators well known in the art such as electrostatic separators may also achieve the desired separation.

During operation, separated H₂-gas is continuously released into a hydrogen line 310 via a hydrogen outlet 315 arranged at the top part of the separator 300, while separated used sorbent A* is continuously released into a first regenerator transport line 320 via a used sorbent outlet 305 arranged at the lower part of the separator 300.

The separated H₂-gas may be guided to a facility for further purification, for example by use of pressure swing adsorption, electrochemical purification or catalytic recombination. Typical temperature, pressure and flow rate in the hydrogen line 310 during operation are 600° C. (±100° C.), 1.2 bara (±0.4 bara) and 208 kg/h (±40 kg/h). As further explained below, the release of gas into the hydrogen line 310 may, in addition to H₂-gas, also include non-reacted gases from the reformer reactor 100 such as CO, CO₂ and fuel gas B (e.g. CH₄).

Separated used sorbent A* is guided from the used sorbent outlet 305 into a dosing system 400 configured to control the flow rate through the first regenerator transport line 320. Typical values of temperature, pressure and flow rate within the first regenerator transport line 320 during operation are 600° C. (±100° C.), 1.2 bara (±0.4 bara) and 2000 kg/h (±600 kg/h).

The dosing system 400 may comprise a tank 410 having one or more tank inlets 405 and one or more tank outlets 415 for receiving used sorbent A* from the separator 300 and for discharging used sorbent A* from the tank 410, respectively.

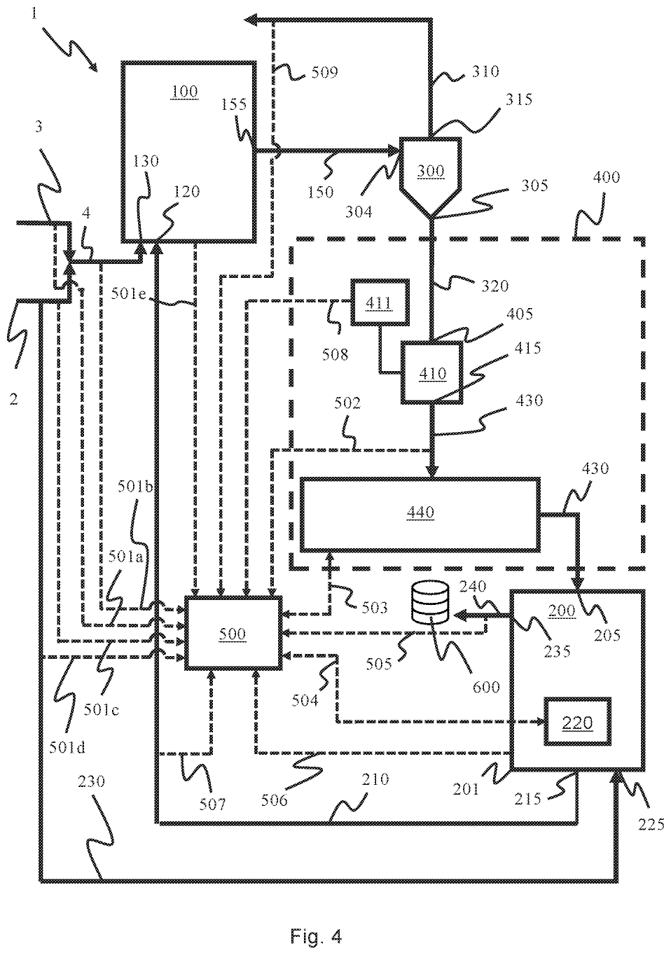

The dosing system 400 may include a tank measuring device 411 for allowing monitoring of operation parameters such as amount of A* within the tank, presence and compositions of other species such as CO, CO₂ and/or CH₄, degree of moisture, etc. In FIGS. 1-4, such a tank measurement device 411 are shown coupled directly to the tank 410. However, measurements may be performed anywhere along the used sorbent transport lines 320, 430, as long as the desired parameters can be achieved. An example of such a tank measurement device 411 is a level measuring device which allows continuous monitoring of the volume of solids present within the tank 410.

After having been discharged from the tank 410 via the tank outlet(s) 415, the used sorbent A* is further guided through a second regenerator transport line 430, 430′ into the regenerator reactor 200 for regenerating/calcinating the used sorbent A* back into the sorbent A and the CO₂-gas. Typical temperature, pressure and flow rate of (primarily sorbent A) entering the regenerator reactor 200 are 850° C. (±100° C.), 1.2 bara (±0.4 bara) and 296 kg/h (±50 kg/h), respectively.

Said regeneration reaction

CaCO₃(s)↔CaO(s)+CO₂(g) (2.6)

is an endothermic reaction requiring supply of energy, usually in the form of added heat. At a typical pressure of 1.1-1.4 bara, a temperature range from 800° C. to 1100° C. may be sufficient temperature to initiate and maintain the regeneration reaction.

The regenerator reactor 200 comprises
a regenerator vessel 201 having an internal volume with a fluidized bed (normally a BFB),
a regenerator power source 220 for providing thermal energy to the used solvent A*,
one or more regenerator inlets 205 for allowing entrance of the used solvent A* from the second regenerator transport line 430′ into the regenerator vessel 201,
one or more CO₂ outlets 235 for allowing discharge of CO₂ out of the regenerator vessel 201 and into one or more CO₂ lines 240,
one or more steam inlets 225 for allowing entrance of C (such as steam C guided from the steam line 2) into the regenerator vessel 201 from one or more steam regenerator lines 230, to fluidize the bed of the regenerator reactor and
one or more sorbent outlets 215 for allowing discharge of hot regenerated sorbent A out of the regenerator vessel 201.

After discharge from the regenerator vessel 201, hot sorbent A is guided through a recycling line 210 back into the reformer reactor 100 via one or more sorbent inlets 120.

The steam C, entering the regenerator vessel 201 from the steam line 2, is pre-heated and has a typical temperature, pressure and flow rate of 750° C. (±75° C.), 1.2 bara (±0.4 bara) and 112 kg/h (±20 kg/h). Upstream the split of the steam line 2 into a flow towards the feed line 4 and the steam regenerator line 230, the steam C has a typical temperature, pressure and flow rate of 120° C., 1.2 bara (±0.4 bara) and 430 kg/h (±75 kg/h).

The CO₂ line 240 guides the discharged CO₂ to an exterior location, typically a CO₂ storage facility 600. Typical temperature, pressure and flow rate within the CO₂ line 240 is 850° C. (±75° C.), 1.2 bara (±0.4 bara) and 296 kg/h (±75 kg/h).

Furthermore, the dosing system 400 may comprise a valve (not shown) such as a one-way valve, configured to open or stop the flow of used sorbent A* into and/or out of the tank 410.

It is known that both kinetics of sorbent and operating pressure profoundly affects the production efficiency of SE-SMR in fluidized bed reactors [see publication Wang, Y. F.; Chao, Z. X.; Jakobsen, H. A. 3D Simulation of bubbling fluidized bed reactors for sorption enhanced steam methane reforming processes. J. Nat. Gas Sci. Eng. 2010, 2, 105-113 and publication Wang, Y. F.; Chao, Z. X.; Jakobsen, H. A. SE-SMR process performance in CFB reactors: Simulation of the CO₂ adsorption/desorption process with CaO based sorbents. Int. J. Greenhouse Gas Control 2011, 5, 489-497].

The inventors hence realized that the ability of monitoring and controlling inter alia the capture efficiency of sorbent A and/or the flow rate R_{A*} of used sorbent A* during the hydrogen production process would be highly advantageous.

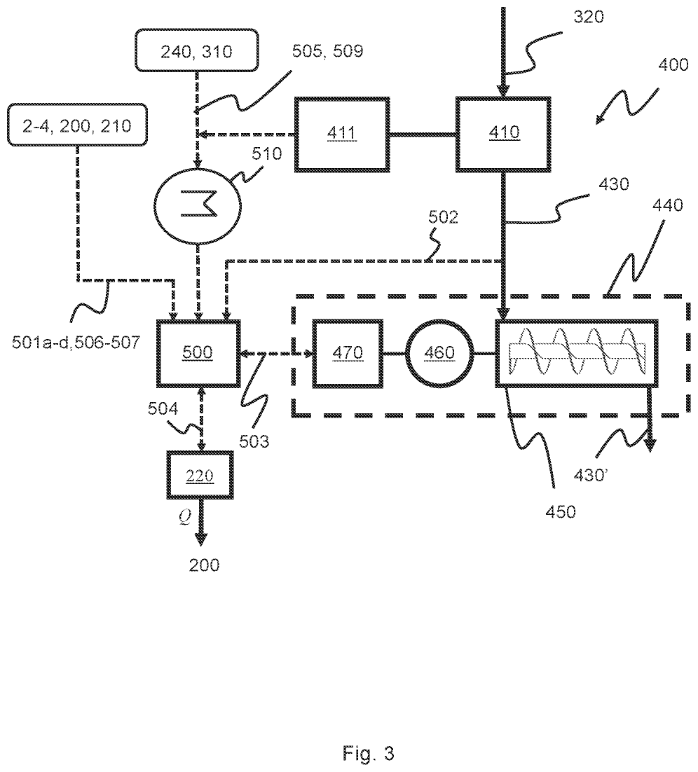

FIG. 3 shows one exemplary configuration of the dosing system 400 of FIGS. 1 and 2, comprising a flow regulating device 440 for controlling the flow rate R_{A*} of the used sorbent A* discharged from the separator 300 and a control system 500 for controlling various operating parameters such as said flow rate R_{A*} and said capture efficiency of sorbent A.

In order to control the flow rate R_{A*}, the flow regulating device 440 comprises in the illustrated exemplary configuration a screw conveyor 450 constituting part of the second regenerator transport line 430, thereby dividing the transport line into an upstream transport line section 430 and a downstream transport line section 430′. To enforce rotational motions of the screw conveyor 450, a motor 460 is rotationally coupled to an end of the screw conveyor 450. Moreover, the ability of regulating the rotational velocity is achieved by connecting a variable speed drive/frequency regulator 470 to the motor 460.

The shown control system 500 is set in signal communication with the variable speed drive 470 for both digital control and monitoring.

In the exemplary configurations depicted in FIG. 1-4, the control system 500 may further receive and/or transmit operating signals from one or more of the other dynamics/components of the system 1 involved in the looped hydrogen production process such as
receiving signals via a fuel material measurement line 501a, indicating flow rate of fuel material B (usually CH₄) flowing in the fuel material line 3 to measure flow rate and/or composition of fuel material B into the reformer reactor 100,
receiving signals via a steam measurement line 501c, indicating flow rate and/or composition of steam C (or other gas separable from CO₂, see above) flowing in the steam line 2 into the reformer reactor 100,
receiving signals via a steam measurement line 501d, indicating flow rate and/or composition of steam C (or other gas separable from CO₂, see above) flowing in the steam line 2 into the regenerator reactor 200,
receiving signals via a feed inlet measurement line 501b, indicating flow rate and/or composition of mixture D flowing in the feed line 4 into the reformer reactor 100,
receiving signals via a reformer measurement line 501e, indicating volume and/or composition of gases and/or solids within the reformer reactor 100,
receiving signals via a used sorbent measurement line 502, indicating flow rate and/or composition of fluids (primarily separated used sorbent A*) flowing in the second regenerator transport line 430 upstream and/or downstream 430′ the flow regulating device 440,
receiving signals via a CO₂ measurement line 505, indicating flow rate and/or composition of gases (mainly CO₂ and steam) discharged from the regenerator vessel 201 into CO₂ line,
transmitting signals via a heat regulation measurement line 504 to the regenerator power source 220 to set a desired power output for heating the used sorbent A* within the regenerator vessel 201,
receiving signals via the heat regulation measurement line 504, or a separate measurement line from the regenerator power source 220, indicating the operating power supplied to the used sorbent A* within the regenerator vessel 201,
receiving signals via a heat measurement line 506 from the regenerator vessel 201 to monitor the temperature of fluids within the regenerator vessel 201,
receiving signals via a regenerated sorbent measurement line 507, indicating flow rate and/or composition of fluid (primarily regenerated sorbent A) discharged from the regenerator vessel 201 into the recycling line 210, receiving signals via a tank measurement line 508, or a separate measurement line directly from the tank 410, indicating operating parameters of the tank 410 such as volume and/or weight of solids/used sorbents A* and
receiving signals via a gas measurement line 509, indicating flow rate and/or composition of gases flowing in the hydrogen line 310.

The control system 500 may receive and/or transmit signals wireless to one or more of the components mentioned above by installing necessary transmitters/receivers, thereby allowing the corresponding measurement line(s) to be omitted.

Moreover, the control system 500 may be connected to other parts of the system 1 to allow monitoring and/or control of these parts.

The flow rate and composition measurements may be performed by a shared measurement system within the control system 500 which includes the necessary measurement means such as a mass flow meter in case of flow rate measurements of used sorbent and regenerated sorbent A; and such as a gas chromatograph, a diode laser spectrometer and/or a combo-probe in case of gas composition measurements. Alternatively, or in addition, the measurements may be performed by dedicated measurement system for the individual measurement lines. As shown in FIG. 3 at least one of the measurements of the flows may require cooling 510 prior to measurements.

If the system 1 comprises the above-mentioned control system 500, various advantageous diagnostics may be obtained.

For example, when considering the reactions occurring in a typical SE-SMR process, CH₄ and CO are consumed through the reforming reaction (2.1) and gas shift reaction (2.2) to produce CO₂ and H₂.

Hence, a reduced ability of the sorbent A to capture CO₂ results in an increase in the amount of CO, CH₄ and CO₂ flowing out of the reformer reactor 100, separated from the used sorbent A* in the separator 300 and released into the hydrogen line 310.

A reduced ability of the sorbent A to capture CO₂ during hydrogen production may thus be monitored by measuring the gas composition into the hydrogen line 310. If the measurements show a gradual increase in at least one of the gases CO, CH₄ and CO₂ it can be interpreted as a decline in the sorbent's ability to capture/adsorb CO₂ within the reformer reactor 100.

As mentioned above, such gas composition measurements may be performed by installing appropriate gas composition measurement devices such as a gas chromatograph (not shown), wherein measurement signals are transmitted through the gas measurement line 509 to the automatic controller 500 which may show the results on a display (not shown) and/or used to calculate (via a processor within the controller 500) new set values for parameters such as energy supply from the regenerator power source 220 (via the heat measurement line 504) or the rotational speed vᵣ of the screw conveyor 450 (via the flow regulation measurement line 503).

In the preceding description, various aspects of the system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Hydrogen production system
2 Steam line
3 Fuel material line
4 Feed line
100 Reformer reactor
120 Sorbent inlet
130 Reformer inlet for mixture D of feed material B and steam C
150 Separator transport line
155 Reformer outlet
200 Regenerator reactor
201 Regenerator vessel
205 Regenerator inlet
210 Recycling line
215 Sorbent outlet
220 Regenerator power source/regenerator heat source
225 Steam inlet
230 Steam regenerator line
235 CO₂ outlet
240 CO₂ line
300 Separator
304 Separator inlet
305 Used sorbent outlet
310 Hydrogen line
315 Hydrogen outlet
320 First regenerator transport line
400 Dosing system
405 Tank inlet
410 Tank
411 Tank measurement device
415 Tank outlet
430 Second regenerator transport line (upstream 440)
430 Second regenerator transport line (downstream 440)
440 Flow regulating device
450 Screw conveyor
460 Motor/electric motor
470 Variable speed drive/frequency regulator
500 Control system/automatic controller
501a Feed inlet measurement line
501b Fuel material measurement line
501c Steam measurement line (reformer reactor)
501d Steam measurement line (regenerator reactor)
501e Reformer measurement line
502 Used sorbent measurement line
503 Flow regulation measurement line
504 Heat regulation measurement line
505 CO₂ measurement line
506 Heat measurement line
507 Regenerate sorbent measurement line
508 Tank measurement line
509 Gas measurement line
510 Cooling system
600 CO₂ storage/reservoir
A Sorbent, CaO
A* Used sorbent, CaCO₃
B Feed material/natural gas
C Steam
D Feed mixture
R_{A*} Flow rate of used sorbent
R_{A*,H} Higher flow rate of used sorbent
R_{A*,L} Lower flow rate of used sorbent
vᵣ Rotation speed of screw conveyor
v_{r;H} Higher rotation speed of screw conveyor
v_{r,L} Lower rotation speed of screw conveyor
Q Heat

1. A system for producing hydrogen gas, the system comprising:
a reformer reactor (100) for containing a carbon dioxide capturing sorbent (A) forming a used sorbent (A*), wherein the reformer reactor (100) is configured to allow reform of a feed material (B) and a steam (C) to produce a reformate gas mixture comprising hydrogen gas (H₂) and carbon dioxide (CO₂), the reformer reactor (100) comprising
a reformer inlet (130) for feeding at least one of the feed material (B) and the steam (C) into the reformer reactor (100) and
a reformer outlet (155) for ejecting the used sorbent (A*) and the hydrogen gas (H₂),
a separator (300) configured to separate the used sorbent (A*) from the hydrogen gas (H₂), the separator (300) comprising
a separator inlet (304) for feeding the hydrogen gas (H₂) and the used sorbent (A*) into the separator (300) and
a separator outlet (305) for ejecting the separated used sorbent (A*),
a separator transport line (150) for transporting the used sorbent (A*) and the hydrogen gas (H₂) from the reformer outlet (155) to the separator inlet (304),
a regenerator reactor (200) comprising
a regenerator inlet (205) for receiving at least a portion of the used sorbent (A*) separated in the separator (300),
a regenerator power source (220) configured to provide sufficient energy to the received used sorbent (A*) for allowing release of carbon dioxide (CO₂), thereby regenerating the sorbent (A), and
a regenerator outlet (215) for ejecting the regenerated sorbent (A),
a regenerator transport line (320,430,430′) for transporting the flow of the used sorbent (A*) from the separator outlet (305) to the regenerator inlet (205) and
a recycling line (210) arranged to transport at least a portion of the regenerated sorbent (A) from the regenerator outlet (215) into the reformer reactor (100), characterized in that the regenerator transport line (320, 430) comprises
a flow regulating device (440) arranged to adjust the flow rate (R_{A*}) of the used sorbent (A*) being transported into the regenerator inlet (205).

2. The system according to claim 1, wherein the regenerator transport line (320,430) further comprises
a tank (410) for containing the separated used sorbent (A*),
a first regenerator transport line (320) coupled at one end to the separator outlet (305) and the other end to a tank inlet (405) of the tank (410) and
a second regenerator transport line (430,430′) coupled at one end to a tank outlet (415) of the tank (410) and the other end to the regenerator inlet (205). I

3. The system according to claim 1, wherein the flow regulating device (440) comprises
a screw conveyor (450) arranged to rotate at an adjustable rotation speed (vᵣ) to regulate the flow rate (R_{A*}) of the used sorbent (A*) into the regenerator reactor (200).

4. The system according to claim 3, wherein the screw conveyor (450) is configured such that the used sorbent (A*) is transported into the regenerator reactor (200) at a higher flow rate (R_{A*,H}) and a lower flow rate (R_{A*,L}) when the screw conveyor (450) is rotating at a higher rotation speed (v_{r;H}) and at a lower rotation speed (v_{r,L}), respectively.

5. The system according to claim 3, wherein the flow regulating device (440) further comprises
a motor (460) rotationally connected to the screw conveyor (450) and
a variable speed drive (470) connected to the motor (460) to enable control of the rotation speed of the motor (460).

6. The system according to claim 1, wherein the system further comprises
an automatic controller (500) in signal communication with the flow regulating device (440), the controller (500) being configured to automatically control operation of the flow regulating device (440) based on at least one of
a flow rate of feed material (B) flowing into the reformer reactor (100),
a flow rate of steam (C) flowing into the reformer reactor (100),
a flow rate of a mixture of feed material (B) and steam (C) flowing into the reformer reactor (100),
a flow rate of the used sorbent (A*) flowing between the reformer outlet (155) and the regenerator inlet (205),
a flow rate of at least carbon dioxide (CO₂) flowing between the reformer outlet (155) and the regenerator inlet (205), and
a flow rate of the hydrogen gas (310), flowing out the separator (300).

7. The system according to claim 1, wherein the system further comprises
an automatic controller (500) in signal communication with the flow regulating device (440), the controller (500) being configured to automatically control operation of the flow regulating device (440) based on at least one of
composition ratios of feed material (B) relative to the total flow of steam (C) flowing into the reformer reactor (100),
composition ratios of chemical compounds of fluid flowing between the reformer outlet (155) and the regenerator inlet (205),
gas composition ratio between carbon monoxide (CO) and unconverted fuel gas flowing between the reformer outlet (155) and the regenerator inlet (205),
gas composition ratio between carbon dioxide (CO₂) and unconverted fuel gas flowing between the reformer outlet (155) and the regenerator inlet (205), and
gas composition measurements in the hydrogen line (310).

8. The system according to claim 1, wherein the reformer reactor (100) includes an amount of the feed material (B), an amount of the steam ((') and an amount of the sorbent (A), wherein the feed material (B) comprises hydrocarbon containing fuel.

9. The system according to claim 1, wherein at least one of the reformer reactors (100) and the regenerator reactor (200) include a fluidized bed.

10. A method for producing hydrogen gas (H₂) using the system according to claim 1, the method comprising the steps of:
A. introducing the feed material (B) and the steam (C) into the reformer reactor (100) via the one or more reformer inlets (130), the reformer reactor (100) containing the sorbent (A) for capturing carbon dioxide (CO₂),
B. reforming the feed material (B) and the steam (C) within the reformer reactor (100) for producing the reformate gas mixture comprising the hydrogen gas (H₂) and the carbon dioxide (CO₂), wherein the sorbent (A) is capturing the carbon dioxide (CO₂) to form the used sorbent (A*),
C. transporting at least a portion of the used sorbent (A*) and at least the portion of the hydrogen gas (H₂) from the reformer reactor (100) to the separator (300) through the separator transport line (150),
D. separating the used sorbent (A*) from the hydrogen gas (H₂) by operating the at least one separator (300),
E. transporting at least a portion of the used sorbent (A*) from the separator (300) to the regenerator reactor (200) through the regenerator transport line (320,430,430′) while adjusting the flow rate (R_{A*}) of the used sorbent (A*) by operating the regulating device (440),
F. providing energy to the used sorbent (A*) within the regenerator reactor (200) to release at least a portion of the carbon dioxide (CO₂) from the used sorbent (A*), at least partly regenerating the sorbent (A) of step A, and
G. recycling at least a portion of the regenerated sorbent (A) of step F by transporting the regenerated sorbent (A) from the regenerator reactor (200) to the reformer reactor (100) through the recycling line (210).

11. The method according to claim 10, wherein the flow regulating device (440) comprises a screw conveyor (450) and wherein the adjustment of the flow rate (R_{A*}) in step E is achieved by adjusting the rotation speed (vᵣ) of the screw conveyor (450).

12. The method according to claim 11, wherein adjusting the rotation speed (vᵣ) of the screw conveyor (450) in step E further comprises
adjusting the screw conveyor (450) to a higher rotation speed (v_{r,H}) for transporting the used sorbent (A*) to the regenerator reactor (200) at a higher flow rate (R_{A*,H}), and
adjusting the screw conveyor to a lower rotation speed (v_{r,L}) for transporting the used sorbent (A*) to the regenerator reactor (200) at a lower flow rate (R_{A*,L}).

13. The method according to claim 10, wherein the flow regulating device (440) further comprises
a motor (460) rotationally connected to the screw conveyor (450), and
a variable speed drive (470) connected to the motor (460) to enable control of the rotation speed of the motor (440), and
wherein the step of adjusting the rotation speed (vᵣ) of the screw conveyor (450) in step E further comprises
operating the variable speed drive (470) for changing the rotation speed of the motor (440).

14. The method according to claim 10, wherein the regenerator transport line (320,430,430′) further comprises
a tank (410) for containing the separated used sorbent (A*),
a first regenerator transport line (320) coupled at one end to the separator outlet (305) and the other end to a tank inlet (405) of the tank (410) and
a second regenerator transport line (430,430′) coupled at one end to a tank outlet (415) of the tank (410) and the other end to the regenerator inlet (205), and
wherein step E further includes
filling the tank (410) to a predetermined minimum amount of the separated used sorbent (A*).

15. The system according to claim 4, wherein the flow regulating device (440) further comprises
a motor (460) rotationally connected to the screw conveyor (450) and
a variable speed drive (470) connected to the motor (460) to enable control of the rotation speed of the motor (460).

16. The system according to claim 5, wherein the system further comprises
an automatic controller (500) in signal communication with the flow regulating device (440), the controller (500) being configured to automatically control operation of the flow regulating device (440) based on at least one of
a flow rate of feed material (B) flowing into the reformer reactor (100),
a flow rate of steam (C) flowing into the reformer reactor (100),
a flow rate of a mixture of feed material (B) and steam (C) flowing into the reformer reactor (100),
a flow rate of the used sorbent (A*) flowing between the reformer outlet (155) and the regenerator inlet (205),
a flow rate of at least carbon dioxide (CO₂) flowing between the reformer outlet (155) and the regenerator inlet (205), and
a flow rate of the hydrogen gas (310), flowing out the separator (300).

17. The system according to claim 6, wherein the system further comprises
an automatic controller (500) in signal communication with the flow regulating device (440), the controller (500) being configured to automatically control operation of the flow regulating device (440) based on at least one of
composition ratios of feed material (B) relative to the total flow of steam (C) flowing into the reformer reactor (100),
composition ratios of chemical compounds of fluid flowing between the reformer outlet (155) and the regenerator inlet (205),
gas composition ratio between carbon monoxide (CO) and unconverted fuel gas flowing between the reformer outlet (155) and the regenerator inlet (205),
gas composition ratio between carbon dioxide (CO₂) and unconverted fuel gas flowing between the reformer outlet (155) and the regenerator inlet (205), and
gas composition measurements in the hydrogen line (310).

18. The system according to claim 7, wherein the reformer reactor (100) includes an amount of the feed material (B), an amount of the steam (C) and an amount of the sorbent (A), wherein the feed material (B) comprises hydrocarbon containing fuel.

19. The system according to claim 7, wherein at least one of the reformer reactors (100) and the regenerator reactor (200) include a fluidized bed.

20. The system according to claim 8, wherein at least one of the reformer reactors (100) and the regenerator reactor (200) include a fluidized bed.
